(19) United States
(12) Patent Application Publication
(10) Pub. No.: US 2011/0068735 A1
(43) Pub. Date: Mar. 24, 2011

(54) Systems and Methods of Accurate Control of Battery Pre-charge Current

(75) Inventors: Richard David Nicholson, Austin, TX (US); Garry Ross Elder, Rockwall, TX (US)

(73) Assignee: Texas Instruments Incorporated, Dallas, TX (US)

(21) Appl. No.: 12/564,911

(22) Filed: Sep. 22, 2009

(51) Int. Cl. H02J 7/00; H02J 7/04

(52) U.S. Cl. 320/107; 320/134

(57) ABSTRACT

Systems and methods for accurate control of battery pre-charge current use external charge FET external discharge FET for accurate control of battery pre-charge current. A low V_{forward} diode or other component and series resistor form a parallel path around the discharge FET. It is preferable for the component to have a voltage drop significantly less than that of the parasitic diode in the FET when carrying current in one direction and substantially higher voltage drop in the other direction. During a pre-charge condition, the discharge FET is turned off, and a servo amplifier monitors the voltage across the series resistor. The servo amplifier controls the gate of the charge FET such that a desired current is flowing from the charger to the battery.

### TECHNICAL FIELD

The present disclosure is generally related to electronics and, more particularly, is related to battery chargers.

### BACKGROUND

Rechargeable batteries are an important power source for today's products, especially for portable appliances such as notebook computers, mobile phones, and digital cameras. The importance of rechargeable batteries is increasing as the usefulness/functionality of portable electronic equipment is increasing. The reasons are several: an ongoing integration of functions (such as a mobile phone with a digital camera), the higher computing speed in notebook computers, and the convenience of large color displays. As a consequence of this high level of power consumption in portable devices, the use of rechargeable batteries has become more cost effective than using a standard battery. Even more important are the environmental benefits of rechargeable batteries. Using rechargeable batteries tremendously reduces the amount of hazardous materials dumped into our environment, the consumption of materials, and the energy required to produce the equivalent in nonrechargeable batteries.

Charging rechargeable batteries is an important facet in maximizing battery use and lifespan. Because fast charging a Li-ion cell can accelerate the degradation of the cell at lower voltages, a much lower charging current, as low as at 1/20 full charge rate, is used to pre-charge the battery. There are many methods of pre-charging with tradeoffs. There are heretofore unaddressed needs with previous pre-charging methods and systems.

### SUMMARY

Example embodiments of the present disclosure provide systems and methods of accurate control of battery pre-charge current. Briefly described, in architecture, one example embodiment of the system, among others, can be implemented as follows: a charge control device comprising a monitor device; a charging driver; a discharging driver; and a semiconductor device configured in parallel with at least one of the charging driver and the discharging driver, the monitor device configured to monitor a voltage drop across a resistor in series with the semiconductor device and to control the current through at least one of the charging driver and the discharging driver.

Embodiments of the present disclosure can also be viewed as providing methods of accurate control of battery pre-charge current. In this regard, one embodiment of such a method, among others, can be broadly summarized by the following: monitoring pre-charge current through a resistor in series with a semiconductor device, the semiconductor device in parallel with at least one of a charging driver and a discharging driver; and controlling the current of at least one of the charging driver and the discharging driver based on the pre-charge current.

### BRIEF DESCRIPTION OF THE DRAWINGS

FIG. 1 is a circuit diagram of an example embodiment of a charger for a battery pack.

FIG. 2 is a circuit diagram of an example embodiment of the battery charger circuit of FIG. 1 with an external pre-charge FET.

FIG. 3 is a circuit diagram of an example embodiment of the battery charger circuit of FIG. 1 with an approximate mirror FET.

FIG. 4 is a circuit diagram of an example embodiment of the battery charger circuit of FIG. 1 with an open circuit gate voltage drive.

FIG. 5 is a circuit diagram of an example embodiment of the battery charger circuit of FIG. 1 with PWM control.

FIG. 6A is a circuit diagram of an example embodiment of systems and methods of accurate control of battery pre-charge current using external n-channel components.

FIG. 6B is a circuit diagram of an example embodiment of systems and methods of accurate control of battery pre-charge current using internal n-channel components.

FIG. 7 is a circuit diagram of an example embodiment of systems and methods of accurate control of battery pre-charge current using external p-channel components.

FIG. 8 is a circuit diagram of an example embodiment of systems and methods of accurate control of battery pre-charge current using external n-channel components, monitoring low-level discharge current.

FIG. 9 is a flow diagram of an example embodiment of methods of accurate control of battery pre-charge current.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

At low temperatures, or when dealing with a heavily discharged battery, some cell chemistries require that the battery is charged with a reduced level of current until said battery reaches an acceptable charge or temperature. Typically this is achieved by either pulsing an in-line field effect transistor (FET) in the battery pack on/off periodically, having a separate high-impedance charge path through a discrete FET device, or by using an intelligent current-limited charger.

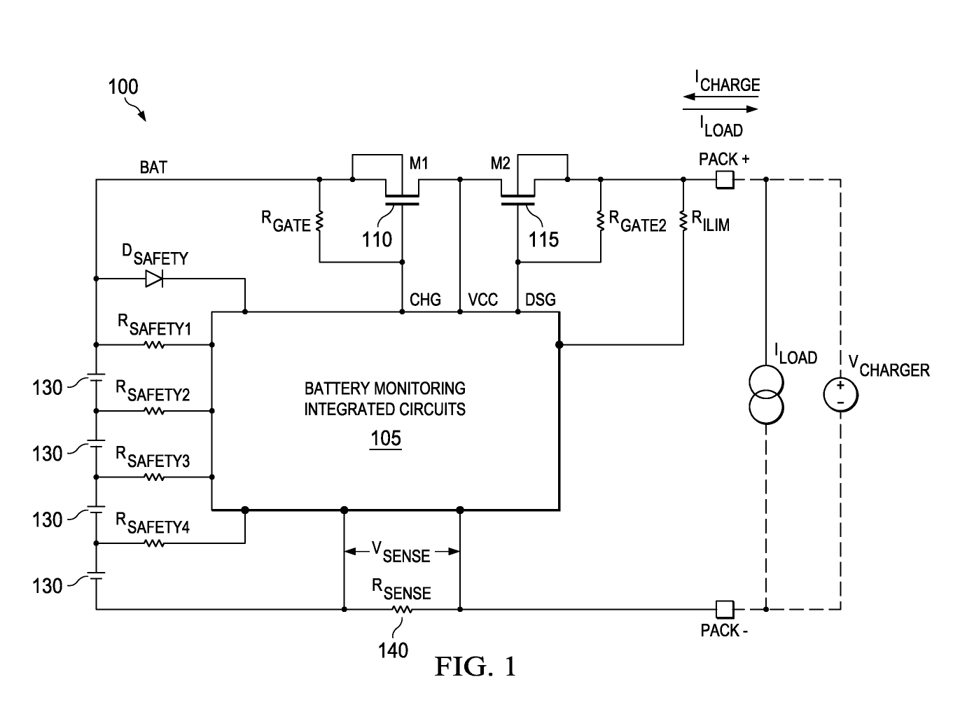

FIG. 1 provides a simplified schematic of a typical lithium-ion battery pack such as those used in most laptop computers and other portable electronic equipment. Although lithium-ion is used in an example embodiment, the systems and methods disclosed herein are applicable to any rechargeable battery chemistry. During pre-charge, it may be preferable for the monitoring electronics to limit the current supplied to the battery to avoid damaging the chemistry.

FIG. 1 provides an example embodiment of one implementation for pre-charge. Circuit 100 of FIG. 1 provides an intelligent current-limited charger. Battery monitoring integrated circuit (IC) 105 monitors the current supplied by battery pack 130 by sensing the voltage drop across resistor 140. Battery monitoring IC 105 controls charge current by controlling field effect transistor (FET) 110. Battery monitoring IC 105 controls discharge current by controlling FET 115. In this approach, charge FET 110 and discharge FET 115 are turned ON. The selected charger determines the approximate state of charge and limits the current supplied to circuit 100. This may be an expensive solution in that much of the electronics required for the intelligent charger already exists in the battery pack causing undesirable duplication of circuitry. There may also be a safety concern if a user connects an incompatible charger.

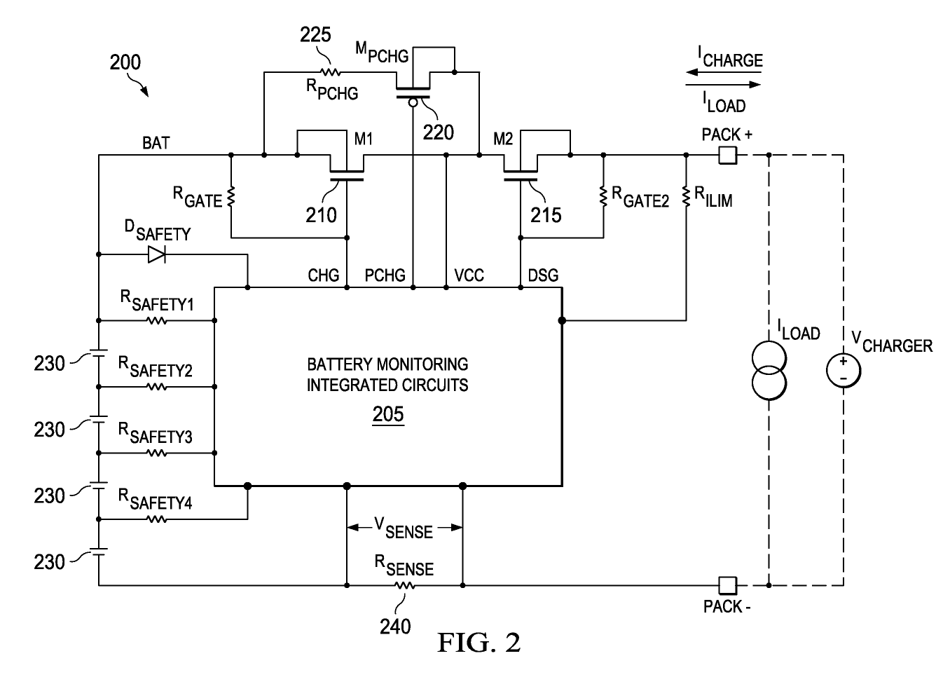

FIG. 2 provides an example embodiment of another implementation for pre-charge. Circuit 200 includes battery monitoring integrated circuit (IC) 205, which monitors the current supplied by battery pack 230 by sensing the voltage drop across resistor 240. Battery monitoring IC 205 controls charge current by controlling field effect transistor 210. Battery monitoring IC 205 controls discharge current by controlling field effect transistor 215. Circuit 200 of FIG. 2 adds external pre-charge FET 220 and series resistor 225 to circuit 100 of FIG. 1. When these components are used, FET 210 is OFF and the pre-charge path is enabled via FET 220. Resistor 225 limits the current into the battery. Circuit 200 of FIG. 2 is a common approach, but requires additional components and the current is not well controlled. The current control largely depends on the battery voltage and the applied charger voltage. Both resistor and MOS device may be integrated into the monitoring integrated circuit (IC), but thermal management becomes difficult as considerable power will then be dissipated by the semiconductor die. If the MOS device is integrated and resistor is not, an extra pin requirement, PCHG, is added to the IC, but thermal management is still an issue, which leads to a large on-chip FET requirement with suitably low on-state resistance.

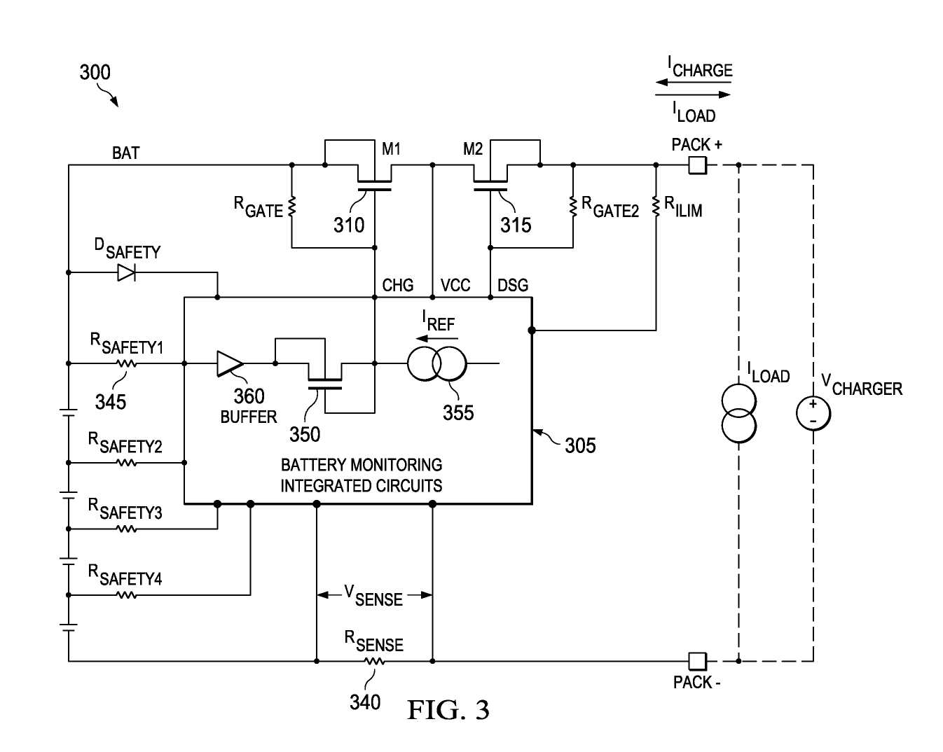

FIG. 3 provides an example embodiment of another implementation for pre-charge control. Circuit 300 of FIG. 3 introduces current driven internal FET 350. FET 350, internal to IC 305, is used to amplify current I_{REF} into external FET 310 in an approximate mirror configuration. The difficulty with this approach is that without specifying the exact external FET to use for FET 310, the current control is poor. Even if the external FET to use for FET 310 is specified, the control current may be poor due to manufacturing tolerances in both IC 305 and external FET 310, including variations over changes in temperature. There will also be inaccuracy at the R_{SAFETY1} input of IC 305 due to R_{SAFETY1}^{*}I_{REF}. Hence, buffer 360 is preferred to avoid this inaccuracy.

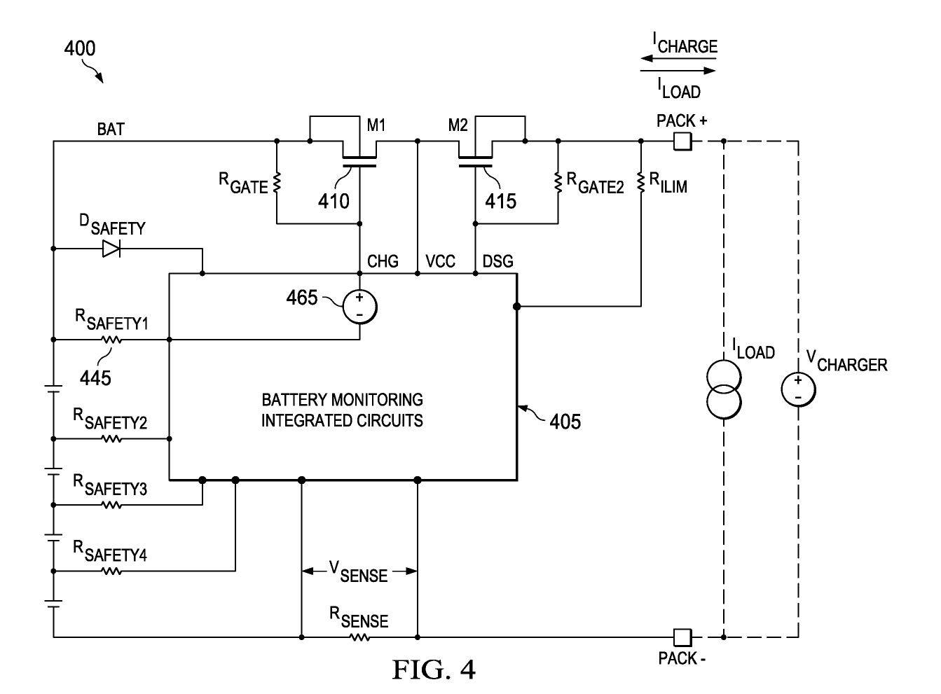

FIG. 4 provides an example embodiment of another implementation for pre-charge. Circuit 400 of FIG. 4 introduces open-loop gate control with open circuit gate voltage drive. Circuit 400 of FIG. 4 works much like circuit 300 of FIG. 3, except that a fixed voltage is programmed on the gate of external FET 410. As in FIG. 3, the variation with different external FETs and temperature may be large.

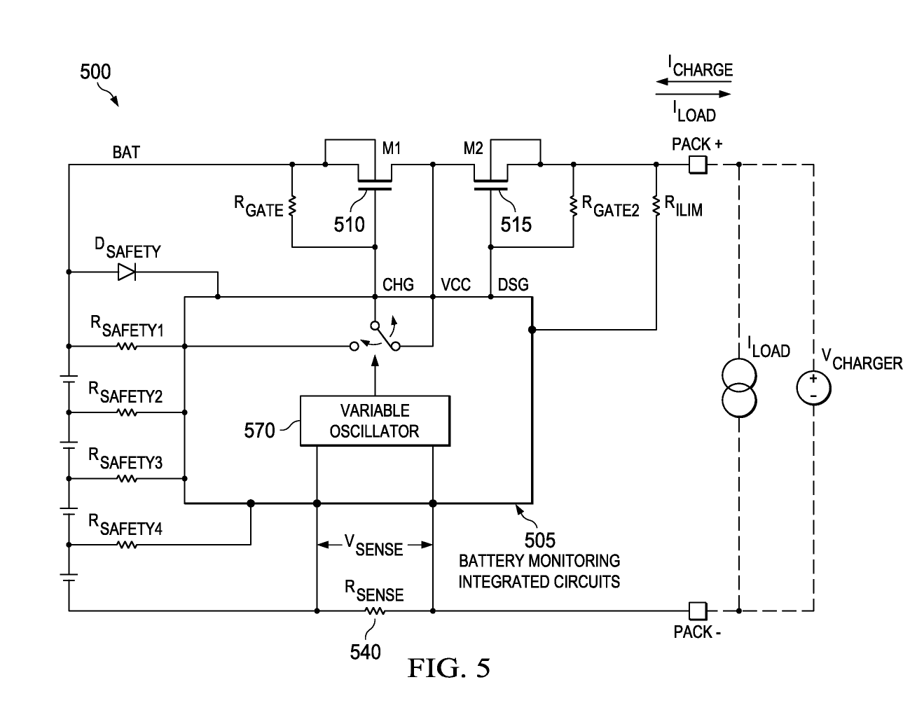

FIG. 5 provides an example embodiment of another implementation for pre-charge. Circuit 500 of FIG. 5 introduces a pulse-mode control or pulse width modulation technique. In the pulse-mode technique, sense resistor 540 is used to sense the pre-charge current. However, Rₛₑₙₛₑ 540 may be very small to prevent excessive power loss during high discharge conditions. As a non-limiting example, 5 mohms may be used as sense resistor 540. The pre-charge current will, then, also be small, such as a non-limiting example of 50 mA. This leads to a voltage drop on sense resistor 540 of only 250 uV. However, controlling this sense voltage to a +/−10% accuracy is not trivial due to offsets within such a control loop.

To amplify this voltage, FET 510 and FET 520 can be turned on at considerably higher current for a non-continuous period of time using variable frequency oscillator 570. Oscillator 570 could also be fixed frequency with variable duty cycle in example embodiments. As a non-limiting example, turning on FET 510 and FET 520 with a duty cycle of 1:10 would result in a peak charge current of 500 mA and a 2.5 mV signal on Rₛₑₙₛₑ 540. This is undesirable because pulsing in this manner creates electromagnetic interference, may confuse a connected charger, is only an approximation of the low current desired for the battery chemistry, and is still difficult to control as sense resistor values are trending downwards to reduce energy losses during operation and to reduce cost and size.

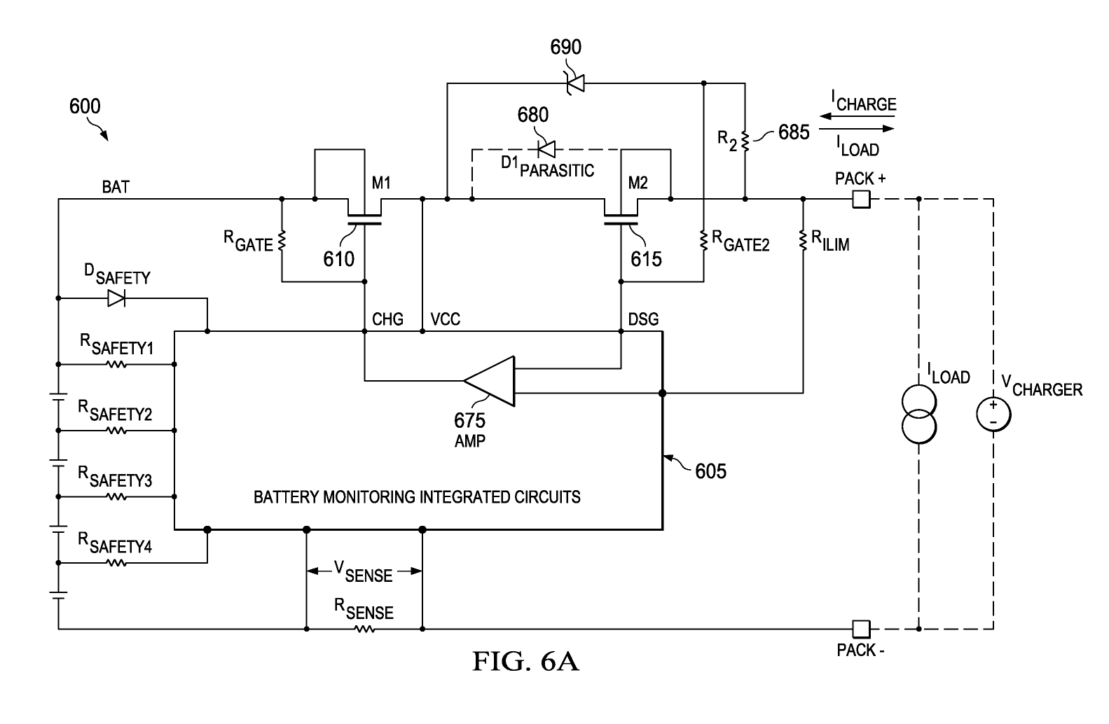

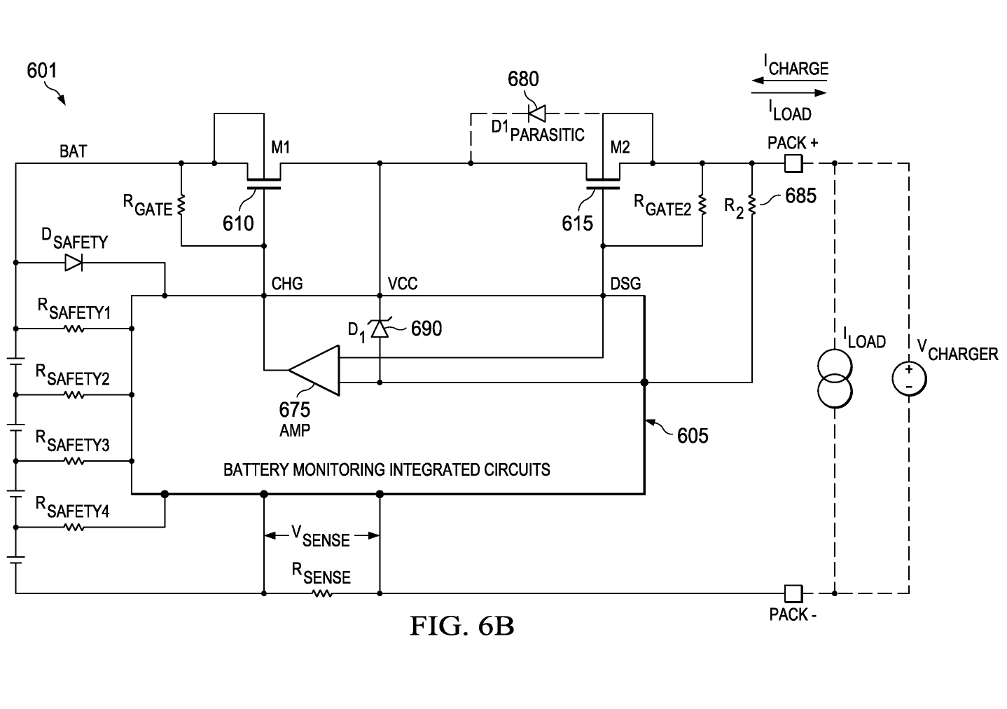

Example embodiments of the systems and methods of accurate control of battery pre-charge current disclosed herein offer improvements over previous solutions. FIG. 6A provides an example embodiment of circuit 600 using external n-channel charge FET 610 and external n-channel discharge FET 615 for accurate control of battery pre-charge current. Low V_{forward} diode 690 and series resistor 685 form a parallel path around discharge FET 615. Diode 690 is shown in FIG. 6A as a Schottky diode (V_{forward} of approximately 0.2V); however, many alternatives embodiments exist (for example, a low threshold metal oxide semiconductor device). It is preferable for the component to have a voltage drop significantly less than that of parasitic diode 680 in FET 615 when carrying current in one direction and substantially higher voltage drop in the other direction. During a pre-charge condition, discharge FET 615 is turned off, and amplifier 675 monitors the voltage across resistor 685. An example embodiment of circuit 600 uses a servo amplifier, which generally includes an integrated feedback loop to actively control the output of amplifier 675 at a desired level. However, other suitable components may be used. Amplifier 675 controls the gate of charge FET 610 such that a desired current is flowing from the charger to the battery.

In an example embodiment, resistor 685 may be integrated into IC 605 for matching purposes. In another example embodiment, as shown in circuit 601 of FIG. 6B, diode 690 may also be integrated into IC 605 to eliminate the external components for this example embodiment of a system for accurate control of battery pre-charge current, without thermal problems since the voltage drop across the resistor/diode combination is less than 0.7V. Excess power in circuit 601 of FIG. 6B may be dissipated across external FET 610. The difference between forward bias voltage of Schottky diode 690 and parallel parasitic diode 680 enables a sizeable voltage (for example, several hundred mV) across resistor 685 before parasitic diode 680 reaches forward bias. This allows circuitry in the control loop to have small area, short design time, and low cost.

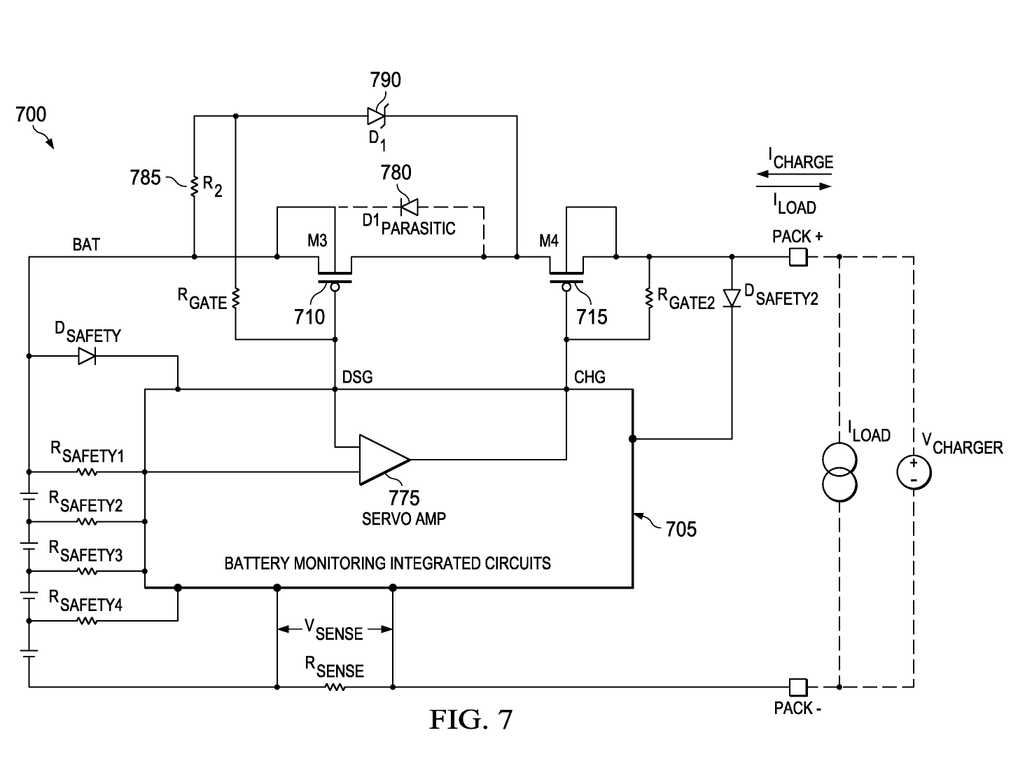

An alternative embodiment is provided in FIG. 7. FIG. 7 provides circuit 700 using external p-channel charge FET 710 and p-channel discharge FET 715.

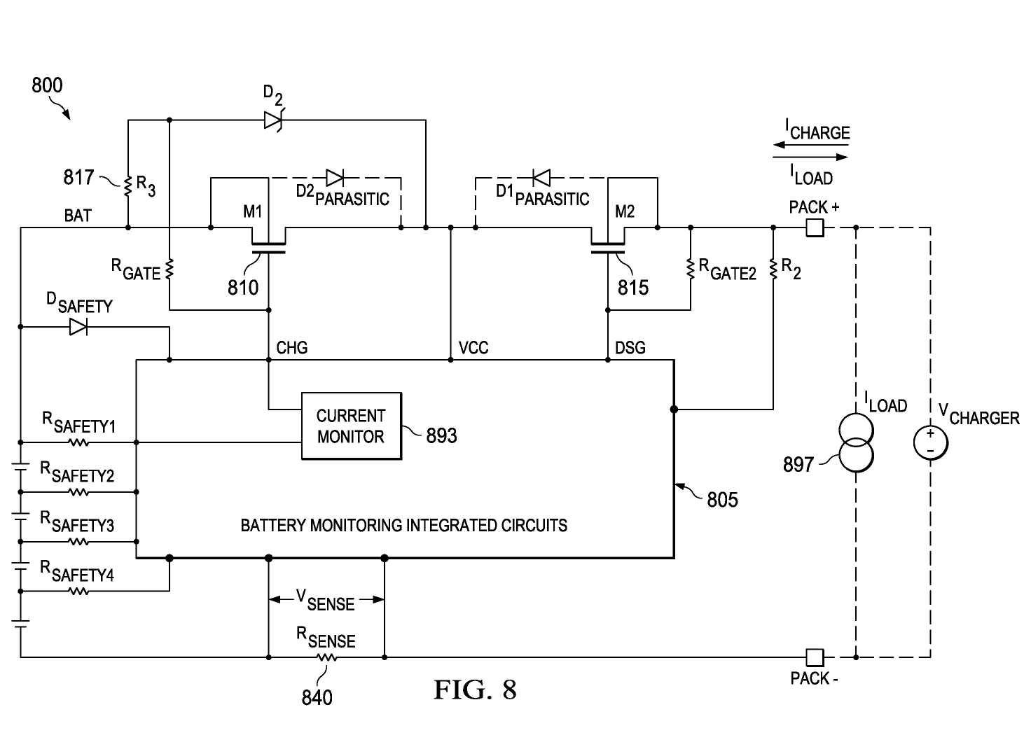

An additional alternative embodiment of systems and methods of accurate control of battery pre-charge current is provided in FIG. 8. In circuit 800 in FIG. 8, a method of accurate control of battery pre-charge current is applied to the discharge path. Rather than control a servo loop in response to sensed current, circuit 800 allows monitoring of very low discharge currents, such as may occur if a load device I_{load} is in a steady state or a shutdown state, drawing greater than zero current, but substantially less than ‘normal operation’ currents. In this alternative embodiment, charge FET 810 is turned off, enabling accurate measurement of small current flow across a substantially larger resistor 817, thereby maintaining accurate state of charge even during load system shutdown or standby modes. In a non-limiting example, resistor 840 may be 5 mohms and the standby load current may be 1 mA with a resulting voltage of 5 uV. If resistor 817 is 300 ohms, then the same 1 mA current discharge produces a 300 mV drop across resistor 817, which is considerably less challenging to accurately monitor.

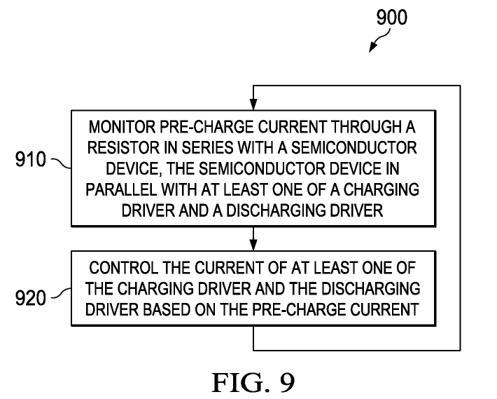

FIG. 9 provides flow diagram 900 of an example embodiment of a method for accurate control of battery pre-charge current. In block 910, the pre-charge current through a resistor in series with a semiconductor device is monitored, the semiconductor device in parallel with at least one of a charging driver and a discharging driver. In block 920, the current of at least one of the charging driver and the discharging driver is controlled based on the pre-charge current.

Therefore, at least the following is claimed:

1. A system for pre-charging a battery comprising:
a charge control device comprising a monitor device;
a charging driver;
a discharging driver; and
a semiconductor device configured in parallel with at least one of the charging driver and the discharging driver, the monitor device configured to monitor a voltage drop across a resistor in series with the semiconductor device and to control the current through at least one of the charging driver and the discharging driver.

2. The system of claim 1, wherein at least one of the charging driver and the discharging driver is an n-channel device.

3. The system of claim 1, wherein at least one of the charging driver and the discharging driver is a p-channel device.

4. The system of claim 1, wherein the semiconductor device is contained in a package comprising the charge control device.

5. The system of claim 1, wherein the resistor in series with the semiconductor device is contained in a package comprising the charge control device.

6. The system of claim 1, wherein the charge control device is a servo amplifier.

7. The system of claim 1, wherein the semiconductor device is in parallel with an n-channel discharging driver.

8. The system of claim 1, wherein the semiconductor device is in parallel with a p-channel charging driver.

9. The system of claim 1, wherein the semiconductor device is at least one of a Schottky diode, a low-threshold metal oxide semiconductor device, and a uni-directional current device with a forward voltage less than the forward voltage of at least one of the charging driver and the discharging driver.

10. A pre-charge control device comprising:
a servo amplifier configured to control a charging driver; and
a semiconductor device configured in parallel with at least one of the charging driver and a discharging driver, the servo amplifier configure to monitor a voltage drop across a resistor in series with the semiconductor device and control the current through at least one of the charging driver and the discharging driver.

11. The pre-charge control device of claim 10, wherein at least one of the charging driver and the discharging driver is an n-channel device.

12. The pre-charge control device of claim 10, wherein at least one of the charging driver and the discharging driver is a p-channel device.

13. The pre-charge control device of claim 10, wherein the resistor in series with the semiconductor device is contained in a package comprising the servo amplifier.

14. The pre-charge control device of claim 10, wherein the semiconductor device is in parallel with an n-channel discharging driver.

15. The pre-charge control device of claim 10, wherein the semiconductor device is in parallel with a p-channel charging driver.

16. The pre-charge control device of claim 10, wherein the semiconductor device is at least one of a Schottky diode, a low-threshold metal oxide semiconductor device, and a uni-directional current device with a forward voltage less than the forward voltage of at least one of the charging driver and the discharging driver.

17. The pre-charge control device of claim 10, wherein.

18. A method comprising:
monitoring pre-charge current through a resistor in series with a semiconductor device, the semiconductor device in parallel with at least one of a charging driver and a discharging driver; and
controlling the current of at least one of the charging driver and the discharging driver based on the pre-charge current.

19. The method of claim 18, wherein at least one of the charging driver and the discharging driver is an n-channel device.

20. The method of claim 18, wherein at least one of the charging driver and the discharging driver is a p-channel device.

21. The method of claim 18, wherein the semiconductor device is contained in a package comprising the charge control device.

22. The method of claim 18, wherein the resistor in series with the semiconductor device is contained in a package comprising the charge control device.

23. The method of claim 18, wherein the controlling the current is performed with a servo amplifier.

24. The method of claim 18, wherein the semiconductor device is in parallel with an n-channel discharging driver.

25. The method of claim 18, wherein the semiconductor device is in parallel with a p-channel charging driver.

26. The method of claim 18, wherein the semiconductor device is at least one of a Schottky diode, a low-threshold metal oxide semiconductor device, and a uni-directional current device with a forward voltage less than the forward voltage of at least one of the charging driver and the discharging driver.
